(19) United States
(12) Patent Application Publication
(10) Pub. No.: US 2014/0293149 A1
(43) Pub. Date: Oct. 2, 2014

(54) CAPACITIVE TOUCH SCREEN AND MANUFACTURING METHOD THEREOF

(71) Applicant: Shenzhen O-Film Tech Co., Ltd, Shenzhen City (CN)

(72) Inventors: GENCHU TANG, Shenzhen City (CN); Shengcai Dong, Shenzhen City (CN); Wei Liu, Shenzhen City (CN); Bin Tang, Shenzhen City (CN)

(73) Assignee: Shenzhen O-Film Tech Co., Ltd, Shenzhen City (CN)

(21) Appl. No.: 13/968,371

(22) Filed: Aug. 15, 2013

Related U.S. Application Data
(63) Continuation of application No. PCT/CN2013/079206, filed on Jul. 11, 2013.

(30) Foreign Application Priority Data
Mar. 27, 2013 (CN) 201310102562.2

(51) Int. Cl. G06F 3/044

(52) U.S. Cl. CPC G06F 3/044
USPC 349/12; 427/532; 427/535

(57) ABSTRACT

A capacitive touch screen includes a substrate provided with a polymer layer, where grid-shaped first direction conductive patterns and grid-shaped second direction conductive patterns are embedded. The first direction conductive patterns are continuously arranged; the second direction conductive patterns are divided into non-communicated conductive units in interval of the first direction conductive patterns. An insulating layer is arranged on the first direction conductive patterns; conductive bridges connect two adjacent conductive units in the second direction; each conductive bridge includes a grid-shaped bridging wire and two conductive blocks; the bridging wires are embedded in the surface of the insulating layer; the two conductive blocks penetrate the insulating layer and respectively connected to one conductive unit; the conductive bridges are separated from the first direction conductive patterns by the insulating layer. The conductive bridges adopt a grid structure, so that transparency can be ensured and appearance of a product is not influenced.

### CROSS-REFERENCE TO RELATED APPLICATIONS

This application is a continuation of International Application No. PCT/CN2013/079206, filed on Jul. 11, 2013, which claims priority to Chinese Patent Application No. 201310102562.2, filed on Mar. 27, 2013, both of which are hereby incorporated by reference in their entireties.

### TECHNICAL FIELD

The invention relates to the field of touch control, in particular to a capacitive touch screen and a manufacturing method thereof.

### BACKGROUND

A touch screen is an inductive device which may receive input signals such as touch. The touch screen gives a new look of information interaction and is a new compelling information interaction device. The development of the touch screen technology has attracted extensive attention of the information media sector and has become an emerging sunrise high-tech industry in the optoelectronic industry. A transparent conductive film is a thin film with good conductivity and high light transmittance in the visible light wave band. Currently, the transparent conductive film has been widely applied to the fields of panel display, photovoltaic devices, touch control panels, electromagnetic shielding and the like and has a very wide market space.

In the conventional One Glass Solution (OGS) technology, Indium Tin Oxide (ITO) is plated on glass, then etching is carried out to obtain required sensor patterns in X and Y directions and finally, molybdenum-aluminium-molybdenum (MoAlMo) is adopted to carry out bridging. However, when MoAlMo is adopted to carry out bridging, formed bridges are not transparent, so metal wires of the metal bridges will appear on the appearance of a product to influence attraction of the product.

### SUMMARY

Therefore, it is necessary to provide a capacitive touch screen with a transparent bridge structure and a manufacturing method thereof.

A capacitive touch screen includes a substrate and is characterized in that the substrate is provided with a polymer layer; a plurality of grid-shaped first direction conductive patterns arranged along a first direction and a plurality of grid-shaped second direction conductive patterns arranged along a second direction are embedded in the polymer layer; the first direction and the second direction are mutually crossed; the first direction conductive patterns are continuously arranged; the second direction conductive patterns are divided into a plurality of non-communicated conductive units at an interval of the first direction conductive patterns; the capacitive touch screen also includes an insulating layer arranged on the first direction conductive patterns and conductive bridges for connecting two adjacent conductive units in the second direction; each of the conductive bridges includes a grid-shaped bridging wire in the middle thereof and two conductive blocks which are positioned at two opposite end portions of the bridging wire and are electrically connected with the bridging wire; the bridging wires are embedded in the surface of the insulating layer; the two conductive blocks each penetrate the insulating layer and are respectively connected to/with corresponding one conductive unit; and the conductive bridges are separated from the first direction conductive patterns by the insulating layer.

In one embodiment, the substrate is made of aluminosilicate glass or soda lime glass.

In one embodiment, the first direction conductive patterns and the second direction conductive patterns are obtained by etching a metal coating attached to a surface of the substrate, and the first direction conductive patterns and the second direction conductive patterns are embedded on a side of the polymer layer close to the substrate.

In one embodiment, the metal coating has a thickness of 5 to 20 nm.

In one embodiment, the metal coating is a silver coating and light transmittance of the silver coating is greater than 80 percent.

In one embodiment, the polymer layer includes a first surface attached to the substrate and a second surface attached to the insulating layer, the second surface is provided with grid-shaped grooves, and the first direction conductive patterns and the second direction conductive patterns are accommodated in the grid-shaped grooves.

In one embodiment, the ratio of depth to width of the grid-shaped grooves on the polymer layer is greater than 1.

In one embodiment, a thickness of the bridging wires is less than that of the insulating layer.

In one embodiment, a surface of the insulating layer is provided with grid-shaped grooves, the bridging wires are formed by conductive materials filled in the grid-shaped grooves, and the conductive materials are selected from at least one of metal, metal alloy, conductive macromolecule, graphene, carbon nanotubes and conductive ink.

In one embodiment, a width of the conductive blocks in the second direction is 1 to 20 μm.

In one embodiment, a width of the conductive blocks in the first direction is 2 to 10 μm.

In one embodiment, the bridging wires are metal grid wires.

In one embodiment, the second direction conductive patterns are arranged in interval in the first direction.

A manufacturing method of a capacitive touch screen includes the following steps:

coating a polymer layer on a surface of a substrate;

patterning the polymer layer to form grid-shaped grooves;

filling a conductive material in the grid-shaped grooves and curing the conductive material to form a plurality of grid-shaped first direction conductive patterns arranged along a first direction and a plurality of grid-shaped second direction conductive patterns arranged along a second direction, where the first direction and the second direction are mutually crossed and the second direction conductive patterns are divided into a plurality of non-communicated conductive units in interval of the first direction conductive patterns;

coating a photoresist layer on the surface of the polymer layer, carrying out exposure on the photoresist layer by utilizing a mask and respectively obtaining photoresist mask layer at positions of two adjacent conductive units by development;

coating a layer of imprinting glue serving as an insulating layer on the surface of the polymer layer coated with the photoresist mask layer;

on the insulating layer, imprinting a grid-shaped bridging wire groove at a position between each two adjacent photoresist mask layers;

removing the photoresist mask layers to form a conductive block groove for connecting the surface of the insulating layer and the surface of the polymer layer; and

filling a conductive material into the bridging wire groove and the conductive block groove and curing the conductive material to obtain a conductive bridge for connecting two adjacent conductive units.

In one embodiment, the substrate is made of aluminosilicate glass or soda lime glass.

In one embodiment, before the step of coating the polymer layer on the surface of the substrate, the surface of the substrate is subjected to bombardment treatment by a plasma beam.

In one embodiment, the ratio of depth to width of the grid-shaped grooves on the polymer layer is greater than 1.

In one embodiment, in the first direction, the second direction conductive patterns are arranged in interval.

As to the capacitive touch screen and the manufacturing method thereof, the conductive bridges adopt a grid structure, so transparency can be ensured and appearance of a product is not influenced.

### BRIEF DESCRIPTION OF DRAWINGS

FIG. 1 shows a schematic structural view of a capacitive touch screen according to an embodiment;

FIG. 2 shows a schematic view of the distribution of first direction conductive patterns and second direction conductive patterns of a capacitive touch screen according to an embodiment;

FIG. 3 shows a schematic view of a filling state of conductive materials of conductive patterns; and

FIG. 4 to FIG. 11 show views of the states of the steps of a manufacturing method of the capacitive touch screen.

### DESCRIPTION OF EMBODIMENTS

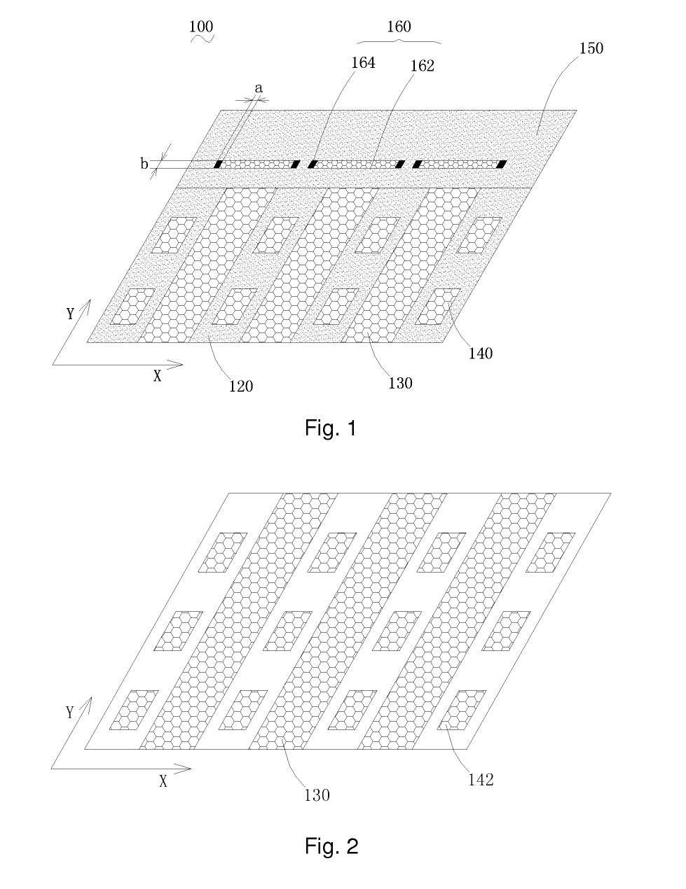

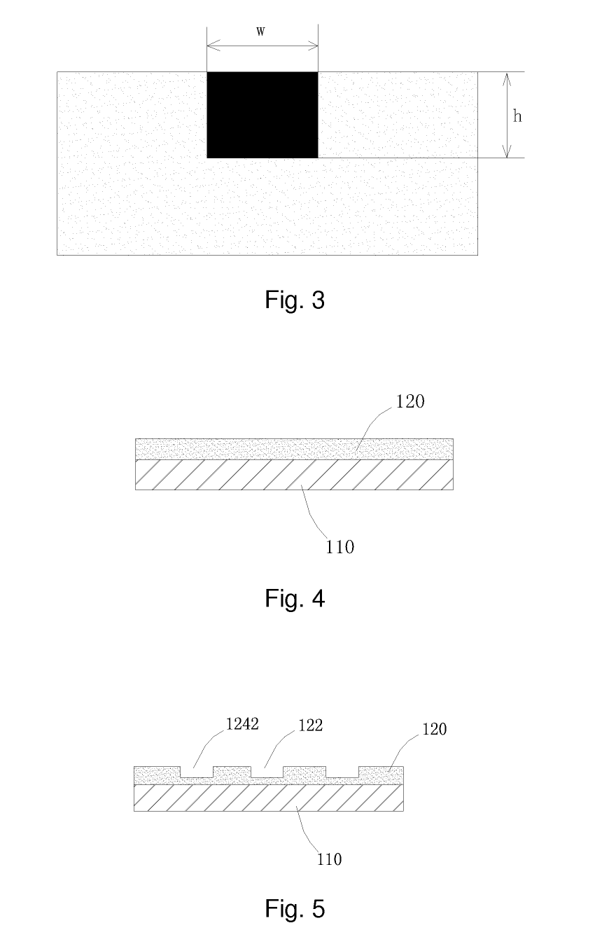

With reference to FIG. 1, FIG. 2 and FIG. 11, a capacitive touch screen 100 of an embodiment includes a substrate 110, a polymer layer 120 arranged on the substrate 110, and a plurality of grid-shaped first direction conductive patterns 130 arranged along a first direction Y and a plurality of grid-shaped second direction conductive patterns 140 arranged along a second direction X, where the plurality of grid-shaped first direction conductive patterns 130 and the plurality of grid-shaped second direction conductive patterns 140 are embedded on a same surface of the polymer layer 120. The first direction Y and the second direction X are mutually crossed and the first direction Y and the second direction X in this embodiment are orthogonal. A conductive layer of the capacitive touch screen 100 is formed by the first direction conductive patterns 130 and the second direction conductive patterns 140.

The first direction conductive patterns 130 are continuously arranged and are communicated with each other. Each second direction conductive pattern 140 is divided into a plurality of conductive units 142 in interval of the first direction conductive patterns 130. An insulating layer 150 is further arranged on the first direction conductive patterns 130 and the second direction conductive patterns 140. Conductive bridges 160 for connecting two adjacent conductive units 142 in the second direction X are embedded in the insulating layer 150. Each conductive bridge 160 includes a grid-shaped bridging wire 162 in the middle thereof and two conductive blocks 164 positioned at two opposite end portions and electrically connected with the bridging wire 162, and the two conductive blocks 164 are respectively connected to one conductive unit 142. Therefore, the two adjacent conductive units 142 are communicated by the conductive bridge 160. The second direction conductive patterns 140 are communicated with each other through arrangement a plurality of conductive bridges 160, and the conductive bridges 160 are separated from the first direction conductive patterns 130 by the insulating layer 150.

In the embodiment, the substrate 110 is transparent glass and is made of aluminosilicate glass or soda lime glass. The substrate 110 commonly has a thickness ranging from 0.3 mm to 1.2 mm, preferably 0.5 mm to 0.7 mm so as to adapt to the requirements of electronic equipment for miniaturization, lightening and thinning.

The polymer layer 120 covers the surface of the substrate 110, and is made of thermoplastic polymer, thermosetting polymer or ultraviolet (UV) curable polymer, and has a thickness of 1 μm to 10 μm, preferably 2 μm to 5 μm so as to adapt to the requirements of electronic equipment for miniaturization, lightening and thinning.

The first direction conductive patterns 130 and the second direction conductive patterns 140 are embedded inside the polymer layer 120. The first direction conductive patterns 130 are continuously distributed and are conductive in the first direction Y. The second direction conductive patterns 140 are divided into a plurality of conductive units 142 spaced by at an interval of the first direction conductive patterns 130 that are not conductive before being connected by the conductive bridges 160, and in the first direction Y, the plurality of second direction conductive patterns 140 are not communicated with each other. Both the first direction conductive patterns 130 and the second direction conductive patterns 140 are of a grid shape and the basic shape of the grid can be an equilateral polygon, such as a square, a diamond and a regular hexagon and also can be an irregular shape. The first direction conductive patterns 130 and the second direction conductive patterns 140 are formed by imprinting grid-shaped grooves of the required patterns on the polymer layer 120, then filling conductive material into the grid-shaped grooves and curing the conductive material. The ratio of depth to width of the grid-shaped grooves is greater than 1, so that the filled conductive material can be well kept in the grid-shaped grooves. In details, the polymer layer 120 includes a first surface (which is unnumbered) attached to the substrate 110 and a second surface (which is unnumbered) attached to the insulating layer, the second surface is provided with grid-shaped grooves, and the first direction conductive patterns 130 and the second direction conductive patterns 140 are accommodated in the grid-shaped grooves. In the embodiment, the widths of grid lines of the first direction conductive patterns 130 and the second direction conductive patterns 140 are 0.2 μm to 5 μm, preferably 0.5 μm to 2 μm. A distance between each two adjacent grid lines is 50 μm to 800 μm. The thickness of metal filled in the grid lines is 1 μm to 10 μm, preferably 2 μm to 5 μm. As shown in FIG. 5, the ratio of thickness h to width w of the grid lines filled with the metal is in the range of 0.5 to 2, preferably 1 to 2. It should be noted that the density of the grid lines and the thickness of the filled metal can be designed according to transmittance and sheet resistance value required by materials.

The insulating layer 150 is positioned on the first direction conductive patterns 130 and is imprinted to obtain the conductive bridges 160. Meanwhile, the insulating layer 150 prevents the conductive bridges 160 from being communicated with the first direction conductive patterns 130 below the conductive bridges 160. The insulating layer 150 is made of thermoplastic polymer, thermosetting polymer or UV curable polymer, can be made of the same material as the polymer layer 120 and also can be made of a different material from the polymer layer 120.

The bridging wires 162 are prepared by imprinting required grid-shaped grooves on the surface of the insulating layer 150 and then filling conductive material into the grid-shaped grooves. Generally, the densities of grid lines of the bridging wires 162 are not greater than densities of the grid lines of the first direction conductive patterns 130 and the second direction conductive patterns 140. The grid lines of the bridging wires 162 have widths of 0.2 μm to 5 μm, preferably 0.5 μm to 2 μm. A distance between each two adjacent grid lines is 50 μm to 500 μm. Thicknesses of the grid lines are 1 μm to 10 μm, preferably 2 μm to 5 μm. Similarly, the basic shape of grids of the bridging wires 162 can be an equilateral polygon, such as a square, a diamond and a regular hexagon and also can be an irregular shape. Thicknesses of the bridging wires 162 are less than that of the insulating layer 150, so that the insulating layer 150 can isolate the bridging wires 162 from the first direction conductive patterns 130.

Each bridging wire 162 is communicated with the discontinuous second direction conductive patterns 140 by two conductive blocks 164 at both the ends of the bridging wire 162, the conductive blocks 164 take a perforating effect, and the bridging wires 162 can be prevented from being communicated with the first direction conductive patterns 130. Each conductive block 164 can be of a straight line shape or an irregular curve shape. To ensure visual transparency, a width a of each conductive block 164 in the second direction X is 1 μm to 20 μm, preferably 2 to 10 μm. A length b of each conductive block 164 only needs to be guaranteed to meet the condition that in the first direction Y, the conductive block 164 is not communicated with the conductive units 142 of the adjacent second direction conductive patterns 140.

The conductive material adopted for the bridging wires 162 and the conductive blocks 164 can be the same as those adopted by the first direction conductive patterns 130 and the second direction conductive patterns 140 or not the same, and are selected from at least one of metal, such as gold, silver, copper and the like, metal alloy, carbon nanotubes, graphene and conductive polymer materials.

As shown in FIG. 4 to FIG. 11, a manufacturing method of a capacitive touch screen is also provided, and the method includes the following steps:

Step 1: A polymer layer is coated on the surface of a substrate. With reference to FIG. 4, in the embodiment, aluminosilicate toughened glass with a thickness of 0.7 mm is used as the substrate 110 and UV-type transparent imprinting glue with a thickness of 5 μm is coated on one surface of the substrate 110 to obtain a polymer layer 120. To reinforce an adhesive force of the surface of the glass panel and the UV glue layer, the surface of the glass panel also can be subjected to bombardment treatment by a plasma beam before the glue is coated, which has the following effects that (1) dirt on the surface of the glass, such as oil stain, is removed and the adhesive force is prevented from being worsened due to the dirt; and (2) the glass panel is ionized so as to improve the adhesive force of the UV glue.

Step 2: Patterning is carried out on the polymer layer to form grid-shaped grooves. With reference to FIG. 5, grid grooves are imprinted on the polymer layer 120 by utilizing a die plate matching with required conductive layer patterns. Please refer to FIG. 1, the grid grooves include a plurality of first direction grooves 122 arranged along a first direction Y and a plurality of second direction grooves; the first direction grooves 122 are continuous; and the second direction grooves are discontinuous and are divided into a plurality of groove units 1242 in interval of the first direction grooves 122. The ratio of depth to width of the grid-shaped grooves on the polymer layer 120 is greater than 1, so that filled conductive material can be well kept in the grid-shaped grooves.

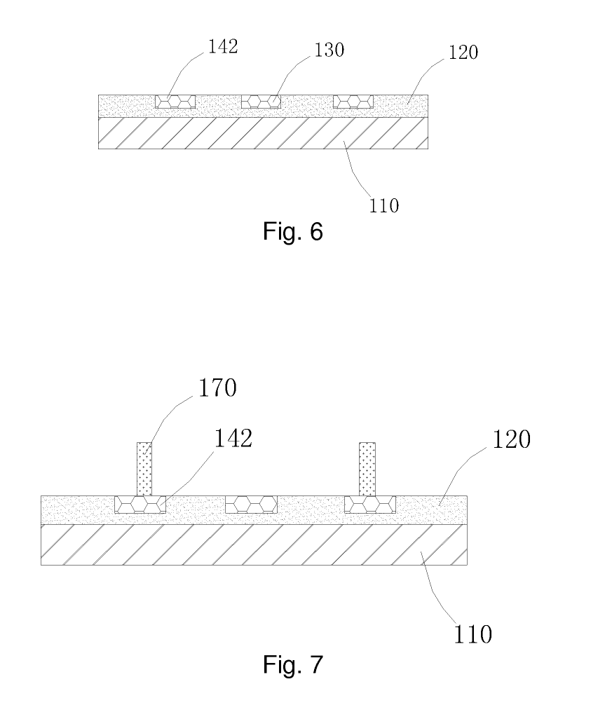

Step 3: The conductive materials are filled into the grid-shaped grooves and are cured to form a plurality of grid-shaped first direction conductive patterns arranged along the first direction and a plurality of grid-shaped second direction conductive patterns arranged along a second direction, where the first direction and the second direction are mutually crossed and the second direction conductive patterns are divided into a plurality of conductive units in interval of the first direction conductive patterns. With reference to FIG. 6, the first direction conductive patterns 130 and the second direction conductive patterns 140 shown in FIG. 1 can be obtained by filling the conductive materials into the grid grooves formed in Step 2 and curing the conductive materials, where the second direction conductive patterns 140 are divided into a plurality of conductive units 142 by the first direction conductive patterns 130 and in the first direction Y, the second direction conductive patterns 140 are not communicated with each other. The first direction conductive patterns 130 and the second direction conductive patterns 140 are of a grid shape and in the process of filling the conductive materials, the conductive materials, such as nano silver ink, can be filled into the grid grooves by utilizing a blade coating technique and then are sintered so as to form the first direction conductive patterns 130 and the second direction conductive patterns 140.

Step 4: A photoresist layer is coated on the surface of the polymer layer, then exposure is carried out on the photoresist layer by utilizing a mask and photoresist mask layers are respectively obtained at the positions of two adjacent conductive units by development. With reference to FIG. 7, the positions of the photoresist mask layers 170 correspond to those of the conductive units 142 and the photoresist mask layers take an effect of a stopper when the conductive materials of the conductive bridges are subsequently filled.

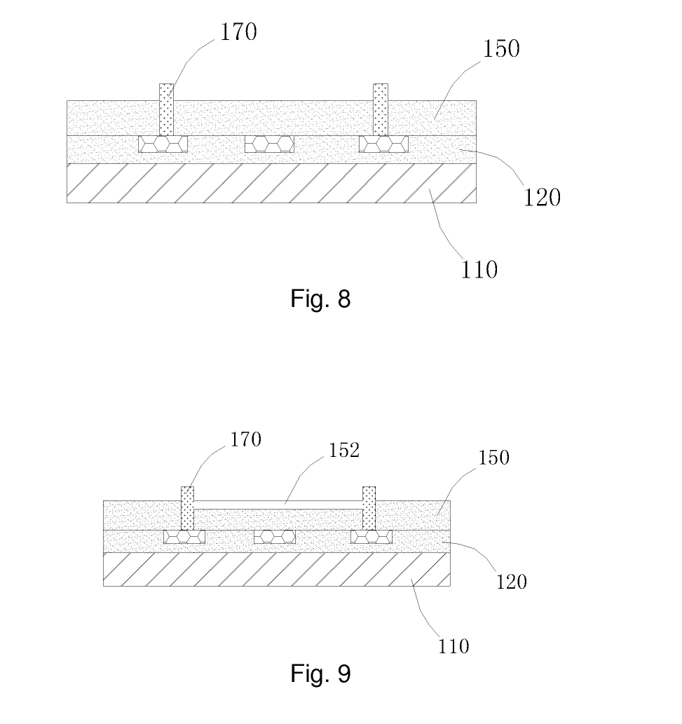

Step 5: A layer of imprinting glue serving as an insulating layer is coated on the surface of the polymer layer, where the surface has been coated with the photoresist mask layers. With reference to FIG. 8, one layer of imprinting glue is coated on the polymer layer 120 to obtain the insulating layer 150. The photoresist mask layers 170 are embedded in the insulating layer 150 and the thickness of the coated imprinting glue is less than those of the photoresist mask layers 170. Coating can adopt a roll coating manner. In the process, the imprinting glue may be remained on the tops of the photoresist mask layers 170, which can be removed together with the subsequent operation of removing the photoresist mask layers 170 and does not influence subsequent steps. Generally, the thickness of the coated imprinting glue is less than those of the photoresist mask layers 170, which aims to ensure that the tops of the photoresist mask layers 170 are exposed out of the upper part of the insulating layer 150 to facilitate subsequent removal of the photoresist mask layers 170. Definitely, if the thickness of the imprinting glue is greater than those of the photoresist mask layers 170, which can be allowed, when the photoresist mask layers 170 are removed subsequently, part of imprinting glue covering the photoresist mask layers 170 can be firstly removed.

Step 6: On the insulating layer, grid-shaped bridging wire grooves are imprinted at the positions between two adjacent photoresist mask layers. With reference to FIG. 9, the grid-shaped bridging wire groove 152 is imprinted at the position between the two photoresist mask layers 170, i.e. the position between the two conductive units 142.

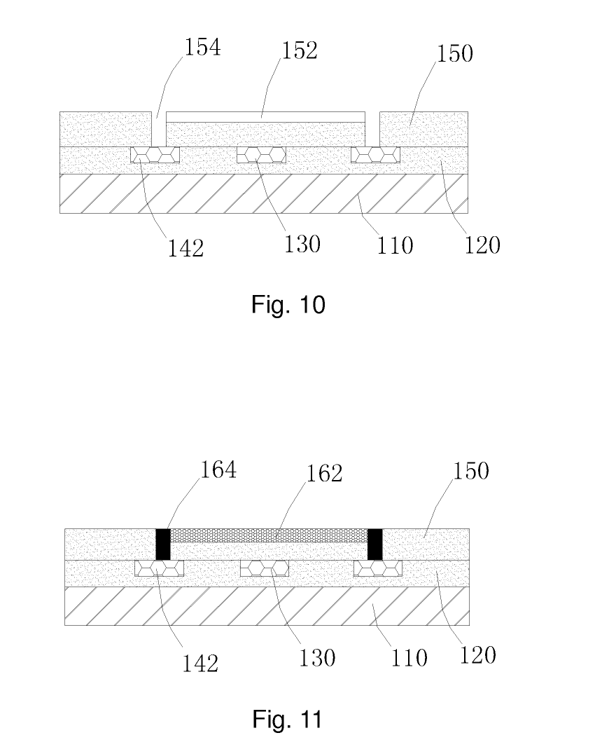

Step 7: The photoresist mask layers are removed to form conductive block grooves for communicating the surface of the insulating layer and the surface of the polymer layer. With reference to FIG. 10, the photoresist mask layers 170 which take an effect of a stopper are removed to obtain the conductive block grooves 154 for communicating the bridging wire grooves 152 on the surface of the insulating layer 150 and the conductive units 142 on the surface of the polymer layer 120. Widths of the conductive block grooves 154 in the second direction X are 1 to 20 μm, preferably 2 to 10 μm, so as to obtain conductive blocks with suitable widths and lengths after conductive material is filled.

Step 8: The conductive materials are filled into the bridging wire grooves and the conductive block grooves and are cured to obtain conductive bridges for communicating two adjacent conductive units. Please refer to FIG. 11 and also combine FIG. 1, after the conductive materials are filled into the bridging wire grooves 152 and the conductive block grooves 154 and are cured, grid-shaped bridging wires 162 in the middles and the conductive blocks 164 at both ends are obtained, so that the conductive bridges 160 are obtained. The conductive blocks 164 take a perforating effect to connect the discontinuous second direction conductive patterns 140. Similarly, the conductive materials, such as nano silver ink, can be filled into the bridging wire grooves 152 and the conductive block grooves 154 by utilizing a blade coating technique and then are sintered so as to form the bridging wires 162 and the conductive blocks at both the ends.

In the capacitive touch screen and the manufacturing method thereof, the first direction conductive patterns 130, the second direction conductive patterns 140 and the bridging wires 162 are all obtained in an imprinting manner. It should be note that the first direction conductive patterns 130 and the second direction conductive patterns 140 also can be obtained by etching a metal coating attached to the surface of the substrate 110 and the first direction conductive patterns 130 and the second direction conductive patterns 140 are embedded on the side of the polymer layer 120 close to the substrate 110. For example, the metal coating can be a silver coating with the thickness of 5 to 20 μm and light transmittance of over 80 percent and metal grid wires are obtained by exposure, development and etching.

The manufacturing method of the capacitive touch screen and the capacitive touch screen manufactured by the method have the following advantages:

(1) The bridging wires of the conductive bridges adopt a grid structure, so that transparency can be ensured and appearance of a product cannot be influenced;

(2) Both the conductive layer and the conductive bridges on the substrate of the capacitive touch screen adopt the grid structure, so in the production process, both the conductive layer and the conductive bridges can be manufactured by adopting an imprinting process and compared with a conventional process of using an Indium Tin Oxide (ITO) film as the conductive layer, the imprinting process has the benefits that the grid shape can be formed in one step, the process is simple, expensive equipment such as sputtering coating equipment, vapor deposition equipment and the like are not required, yield is high, suitable for large-area screen and mass production, and since an etching process does not need to be adopted, waste of materials of the conductive layer cannot be caused;

(3) The conductive layer and the conductive bridges adopt the grid structure, which is convenient to adopt a blade coating process and prevent the fracture of the wires caused by condensation effect occurring during the sintering process;

(4) Both the conductive layer and the conductive bridges can be obtained in a manner of forming the grid wires by metal without using ITO, so that material cost is greatly reduced, and the problems of low response speed and the like of a large-scale touch panel, which are caused by an excessive sheet resistance of the ITO, also can be solved; and

(5) The conductive materials are embedded into the polymer layer, so the wires of the conductive layer and the conductive bridges can be avoided from being scratched.

The above embodiments only describe several implementing modes of the present invention in details and should not be understood as a limit to the protection scope of the invention. It should be noted that: for those skilled in the art, on the premise of not deviating from the principle of the invention, several modifications and improvements also can be derived, which all belong to the protection scope of the invention. Therefore, the protection scope of the present invention shall be based on the attached claims.

What is claimed is:

1. A conductive touch screen, comprising a substrate, an insulating layer and conductive bridges, wherein the substrate is provided with a polymer layer; a plurality of grid-shaped first direction conductive patterns arranged along a first direction and a plurality of grid-shaped second direction conductive patterns arranged along a second direction are embedded in the polymer layer; the first direction and the second direction are mutually crossed; the first direction conductive patterns are continuously arranged; the second direction conductive patterns are divided into a plurality of non-communicated conductive units in interval of the first direction conductive patterns; the insulating layer is arranged on the first direction conductive patterns; each of the conductive bridges connects two adjacent conductive units in the second direction; each of the conductive bridges comprises a grid-shaped bridging wire in the middle thereof and two conductive blocks which are positioned at two opposite end portions and are connected with the bridging wire; the bridging wires are embedded in the surface of the insulating layer; the two conductive blocks each penetrate the insulating layer and are respectively connected to corresponding one conductive unit; and the conductive bridges are separated from the first direction conductive patterns by the insulating layer.

2. The capacitive touch screen according to claim 1, wherein the substrate is made of aluminosilicate glass or soda lime glass.

3. The capacitive touch screen according to claim 2, wherein the first direction conductive patterns and the second direction conductive patterns are obtained by etching a metal coating attached to a surface of the substrate; and the first direction conductive patterns and the second direction conductive patterns are embedded on a side of the polymer layer close to the substrate.

4. The capacitive touch screen according to claim 3, wherein the metal coating has a thickness of 5 to 20 nm.

5. The capacitive touch screen according to claim 4, wherein the metal coating is a silver coating with a light transmittance greater than 80 percent.

6. The capacitive touch screen according to claim 1, wherein the polymer layer comprises a first surface attached to the substrate and a second surface attached to the insulating layer; the second surface is provided with grid-shaped grooves; and the first direction conductive patterns and the second direction conductive patterns are accommodated in the grid-shaped grooves.

7. The capacitive touch screen according to claim 6, wherein the ratio of depth to width of each of the grid-shaped grooves on the polymer layer is greater than 1.

8. The capacitive touch screen according to claim 1, wherein a thickness of the bridging wires is less than that of the insulating layer.

9. The capacitive touch screen according to claim 1, wherein a surface of the insulating layer is provided with grid-shaped grooves; the bridging wires are formed by a conductive material filled in the grid-shaped grooves; and the conductive material is at least one kind selected from of metal, metal alloy, conductive macromolecule, graphene, carbon nanotubes and conductive ink.

10. The capacitive touch screen according to claim 1, wherein a width of the conductive blocks in the second direction is 1 to 20 μm.

11. The capacitive touch screen according to claim 10, wherein a width of the conductive blocks in the first direction is 2 to 10 μm.

12. The capacitive touch screen according to claim 1, wherein the bridging wires are metallic grid wires.

13. The capacitive touch screen according to claim 1, wherein the second direction conductive patterns are arranged in interval in the first direction.

14. A manufacturing method of a capacitive touch screen, comprising:
coating a polymer layer on a surface of a substrate;
patterning the polymer layer to form grid-shaped grooves;
filling a conductive material in the grid-shaped grooves and curing the conductive material to form a plurality of grid-shaped first direction conductive patterns arranged along a first direction and a plurality of grid-shaped second direction conductive patterns arranged along a second direction, wherein the first direction and the second direction are mutually crossed and the second direction conductive patterns are divided into a plurality of non-communicated conductive units in intervals of the first direction conductive patterns;
coating a photoresist layer on a surface of the polymer layer, carrying out exposure on the photoresist layer by utilizing a mask, and respectively obtaining a photoresist mask layer at the positions of two adjacent conductive units by development;
coating a layer of imprinting glue serving as an insulating layer on the surface of the polymer layer coated with the photoresist mask layer;
on the insulating layer, imprinting a grid-shaped bridging wire groove at a position between each two adjacent photoresist mask layers;
removing the photoresist mask layers to form a conductive block groove for communicating the surface of the insulating layer with the surface of the polymer layer; and
filling a conductive material into the bridging wire groove and the conductive block groove, and curing conductive material to obtain a conductive bridge for connecting two adjacent conductive units.

15. The manufacturing method of the capacitive touch screen according to claim 14, wherein the substrate is made of aluminosilicate glass or soda lime glass.

16. The manufacturing method of the capacitive touch screen according to claim 14, wherein before the step of coating the polymer layer on the surface of the substrate, the surface of the substrate is subjected to bombardment treatment by a plasma beam.

17. The manufacturing method of the capacitive touch screen according to claim 14, wherein the ratio of depth to width of the grid-shaped grooves on the polymer layer is greater than 1.

18. The manufacturing method of the capacitive touch screen according to claim 14, wherein in the first direction, the second direction conductive patterns are arranged in interval.
